(19) United States
(12) Patent Application Publication
(10) Pub. No.: US 2026/0058746 A1
(43) Pub. Date: Feb. 26, 2026

(54) MODEL MONITORING USING A REFERENCE MODEL

(71) Applicant: QUALCOMM Incorporated, San Diego, CA (US)

(72) Inventors: Jay Kumar SUNDARARAJAN, San Diego, CA (US); Chenxi HAO, Beijing (CN); Taesang YOO, San Diego, CA (US); June NAMGOONG, San Diego, CA (US); Naga BHUSHAN, San Diego, CA (US)

(21) Appl. No.: 19/101,236

(22) PCT Filed: Sep. 30, 2022
(86) PCT No.: PCT/CN2022/123109

§ 371 Date: Feb. 4, 2025

(51) Int. Cl. H04B 17/391; H04L 41/16; H04W 24/02

(52) U.S. Cl. CPC H04B 17/3913; H04L 41/16; H04W 24/02

(57) ABSTRACT

An apparatus, method and computer-readable media are disclosed for performing wireless communications. An example method of wireless communication includes method performed at a user equipment (UE). The method includes generating a first representation of control information associated with a communication channel using a machine learning model under test, generating a second representation of the control information associated with the communication channel using a reference machine learning model and transmitting, to a device, information associated with a comparison based on the first representation of the control information and the second representation of the control information. The comparison can occur on the UE or on the device and can be based on the representations of the control information or reconstructed representations of the control information.

### FIELD

The present disclosure generally relates to machine learning (ML) systems for wireless communications. For example, aspects of the present disclosure relate to systems and techniques for monitoring a performance of a machine learning model deployed at a device using one or more reference machine learning models.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML based algorithms may be incorporated into the 5G and future standards to improve telecommunications and data services. Such ML based algorithms can be trained for specific environments such as indoor versus outdoor environments.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein that monitor the performance of one or more test machine learning (ML) models (e.g., a test neural network model) using one or more reference ML models (e.g., a reference neural network model) to identify cases where reconstructed control information (e.g., channel state information (CSI) is different from target control information (e.g., CSI) that a device intended to convey. In some aspects, a test ML model deployed on a first device (e.g., a user equipment (UE), a base station or a portion of the base station such as a central unit (CU), a distributed unit (DU), a radio unit (RU), etc.) can be monitored at a second device (e.g., a base station, a UE, etc.) based on data received at the second device from the first device.

In some cases, the data received at the second device can be based on an output generated at the first device using the test ML model and an output generated at the first device using the reference ML model. For example, an encoder of a test ML model on the first device can be trained to generate a compressed representation (e.g., a latent representation such as a latent code) of control information associated with a communication channel, such as CSI or other control information. An encoder of a reference ML model on the first device can also be trained to generate a compressed representation of the control information (e.g., CSI) associated with the communication channel. The first device can transmit the compressed representations of the control information to the second device. Upon receiving the two compressed representations of the control information, the second device can reconstruct the control information from each respective compressed representation using a decoder of an ML model deployed on the second device. If a difference between both versions of the reconstructed control information (e.g., reconstructed CSI) is below a threshold difference, the second device can determine that a performance of the test model deployed on the first device is accurate for the communication channel. In some cases, the CSI corresponds to or includes precoding vectors. In such cases, metrics such as the normalized mean squared error (NMSE) or the cosine similarity metric can be used to determine the threshold difference. As an example, the threshold difference can be −10 dB based on the NMSE calculation. For instance, a test model can be determined to be accurate for a communication channel if a value based on the NMSE calculation is −10 dB or lower. Other values are contemplated as well. If the difference between both versions of the reconstructed control information (e.g., reconstructed CSI) is greater than (or not below) the threshold difference, the second device can determine that the performance of the test model deployed on the first device is inaccurate for the communication channel.

In other aspects, the monitoring or comparisons described herein for determining an accuracy or adequacy of a test ML model can be performed on the first device or on both the first device and the second device. For instance, in some cases, the first device can monitor the ML model deployed on the first device, such as by comparing an output generated using the test ML model and an output generated using the reference ML model.

According to at least one example, a method of wireless communications is performed at a user equipment (UE). The method includes: generating a first representation of control information associated with a communication channel using a machine learning model under test; generating a second representation of the control information associated with the communication channel using a reference machine learning model; and transmitting, to a device, information associated with a comparison based on the first representation of the control information and the second representation of the control information.

In another aspect, an apparatus for wireless communications can include at least one memory and at least one processor coupled to the at least one memory. The at least one processor can be configured to: generate a first representation of control information associated with a communication channel using a machine learning model under test; generate a second representation of the control information associated with the communication channel using a reference machine learning model; and transmit, to a device, information associated with a comparison based on the first representation of the control information and the second representation of the control information.

In another aspect, a non-transitory computer-readable medium is provided having instructions that, when executed by one or more processors, cause the one or more processors to: generate a first representation of control information associated with a communication channel using a machine learning model under test; generate a second representation of the control information associated with the communication channel using a reference machine learning model; and transmit, to a device, information associated with a comparison based on the first representation of the control information and the second representation of the control information.

In another example, an apparatus for wireless communications can include: means for generating a first representation of control information associated with a communication channel using a machine learning model under test; generating a second representation of the control information associated with the communication channel using a reference machine learning model; and transmitting, to a device, information associated with a comparison based on the first representation of the control information and the second representation of the control information.

In some aspects, one or more of the apparatuses described herein is, is part of, and/or includes a user equipment (UE) such as a wireless communication device (e.g., a mobile device such as a mobile telephone or other mobile device), an extended reality device (e.g., a virtual reality (VR) device, an augmented reality (AR) device, or a mixed reality (MR) device), a vehicle or a computing system, device, or component of the vehicle, a network-connected wearable device (e.g., a network-connected watch), a camera, a personal computer, a laptop computer, a server computer, or other UE. In some aspects, one or more of the apparatuses described herein is, is part of, and/or includes a base station (e.g., an eNodeB, a gNodeB, or other base station) or a portion of a base station (e.g., a central unit (CU), a distributed unit (DU), a radio unit (RU), or other portion of a base station having a disaggregated architecture). In some cases, the apparatus(es) include a camera or multiple cameras for capturing one or more images. In some examples, the apparatus(es) include a display for displaying one or more images, notifications, and/or other displayable data. In some aspects, the apparatus(es) include one or more sensors (e.g., one or more inertial measurement units (IMUs), such as one or more gyroscopes, one or more gyrometers, one or more accelerometers, any combination thereof, and/or other sensor). In some examples, the apparatus(es) include a receiver, a transmitter, or a transceiver for receiving and/or transmitting information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIG. 7A illustrates a block diagram associated with providing a scenario to test a machine learning model on a user equipment, in accordance with aspects of the present disclosure;

FIG. 7B illustrates a UE-side set of models for different scenarios and a NW-side set of models for the different scenarios, in accordance with aspects of the present disclosure;

FIG. 7C illustrates the transmission of compressed data from different models on a UE to a gNB to decompress the data via its different models, in accordance with aspects of the present disclosure;

FIG. 7D illustrates the transmission of compressed data from different models on a UE to a gNB to decompress the data via a generic model, in accordance with aspects of the present disclosure;

FIGS. 8A-8B illustrate various flow diagrams associated with different aspects of testing an adequacy of a machine learning model, in accordance with aspects of the present disclosure; and

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3^{rd} Generation Partnership Project (3GPP) 5G/New Radio (NR) Standard) to provide improvements to wireless communications. A device (e.g., a UE) can be configured to generate or determine control information related to a communication channel upon which the device is communicating or is configured to communicate. For example, a UE can monitor a channel to determine information indicating a quality or state of the channel, which can be referred to as channel state information (CSI). In some cases, using an ML-based air interface, a first network device (e.g., a UE) and a second network device (e.g., a gNB) may use trained ML models to implement a function. For instance, a UE that intends to convey CSI to the gNB can use a neural network to derive a compressed representation of the CSI for transmission to the gNB. The gNB may use another neural network to reconstruct the target CSI from the compressed representation. In such cases, there is a need to monitor the performance of the ML model at the UE and detect scenarios where the ML model performance is inadequate (e.g., when the reconstructed CSI is very different from the target CSI that the UE intended to convey to the gNB).

In some cases, different ML models can be trained for different scenarios. For example, a first ML model may be trained to generate a compressed representation of control information (e.g., CSI) using training data that is specific to indoor environments and a second ML model may be trained to generate a compressed representation of the control information (e.g., CSI) using training data that is specific to outdoor environments. In another example, the first ML model may be trained to generate a compressed representation of control information (e.g., CSI) using training data that is specific to line-of-sight (LOS) scenarios (e.g., without any occlusions, such as buildings) and the first ML model may be trained to generate a compressed representation of control information (e.g., CSI) using training data that is specific to non-line-of-sight (NLOS) scenarios. Other examples of different scenarios for which ML models can be trained include scenarios based on geographic location (e.g., region specific), based on different serving cells, different scenario classes based on different statistics of the channel (e.g., delay spread, signal-to-noise ratio (SNR), ML-based features, etc.).

In such cases, if an ML model of a device is trained using training data samples from one scenario, the ML model may not perform well if used during inference or test time in a different scenario. For example, there may be a mismatch in the reconstructed control information generated from a compressed representation of the control information generated by an ML model as compared to target control information (e.g., CSI) that the device intended to convey. In one illustrative example, an ML model on a UE can be trained using training data from a first type of indoor environment, but when the test model is used at inference or test time, the UE may have moved to a different type of indoor environment or may have moved to an outdoor environment. In such an example, there may be a mismatch between the compressed representation of the control information output by the ML model as compared to the target control information.

As noted above, systems and techniques are described herein for monitoring the performance of one or more test machine learning (ML) models (e.g., a test neural network model) using one or more reference ML model (e.g., a reference neural network model) to identify cases where reconstructed control information is different from target control information that a device intended to convey. The control information can include any type of control information or data that may need to be transmitted from a first network device to a second network device. One non-limiting example of control information is CSI. Another non-limiting example of control information is a reference signal, such as a demodulation reference signal (DMRS), a tracking reference signal (TRS), a positioning reference signal (PRS), a sounding reference signal (SRS), and/or other type of reference signal.

When a network device (e.g., gNB) is determining whether reconstructed control information (e.g., CSI) received from another network device (e.g., UE) is close to the target CSI, the network device needs to know the original target CSI that is originally determined by the other network device. The target control information can be considered as a “ground truth” or the actual condition of the channel. However, transmitting the target control information in its original form to the network device may require significant overhead and may reduce the benefit of using the ML model to compress the control information. According to aspects described herein, a first network device can compress the ground truth control information using a test ML model to generate a first compressed representation of the control information and can compress the ground truth control information using a reference ML model to generate a second compressed representation of the control information.

Performance of the test model can be monitored by making a comparison based on the first and second compressed representations to determine an accuracy or adequacy of the test ML model, such as by comparing the compressed representations themselves or by comparing respective reconstructed control information determined using the compressed representations. The monitoring or comparisons described herein for determining an accuracy or adequacy of a test ML model can be performed by the first network device, by a second network device to which the first network device transmits the compressed representations, or on both the first network device and the second network device.

According to some aspects, a test ML model deployed on a first network device can be monitored at a second network device based on data received at the second network device from the first network device (e.g., based on an output generated at the first network device using the test ML model and an output generated at the first network device using the reference ML model). For example, an encoder of a test ML model on the first network device can be trained to generate a compressed representation (e.g., a latent representation such as a latent code) of control information associated with a communication channel, such as CSI indicative of a quality or state of the communication channel or other control information. An encoder of a reference ML model on the first network device can also be trained to generate a compressed representation of the control information (e.g., CSI) associated with the communication channel.

The first network device can transmit the compressed representations of the control information to the second network device. Upon receiving the two compressed representations of the control information, the second network device can reconstruct the control information from each respective compressed representation using a decoder of an ML model deployed on the second network device. If a difference between both versions of the reconstructed control information (e.g., reconstructed CSI) is below a threshold difference, the second network device can determine that a performance of the test model deployed on the first network device is accurate for the communication channel. If the difference between both versions of the reconstructed control information (e.g., reconstructed CSI) is greater than (or not below) the threshold difference, the second network device can determine that the performance of the test model deployed on the first network device is inaccurate for the communication channel.

The second network device can transmit information (e.g., on a downlink channel such as a physical downlink control channel (PDCCH) or a physical downlink shared channel (PDSCH), on an uplink channel such as a physical uplink control channel (PUCCH) or a physical uplink shared channel (PUSCH), or on a sidelink channel such as a physical sidelink control channel (PSCCH) or a physical sidelink shared channel (PSSCH)) indicating a result of the comparison to the first network device. Based on the received information, the first network device can update the test ML model (e.g., by re-training the test ML model), switch to a different ML model (e.g., an ML model that is trained for a different scenario), any combination thereof, and/or perform any other suitable operation.

In some cases, the ML model deployed on the first network device may be trained using training data including conditions for a specific scenario (e.g., an indoor environment, an outdoor environment, for a specific cell, for a specific geographic location, etc.), and the ML model deployed on the second network device may be trained using training data including conditions for multiple scenarios (e.g., for indoor and outdoor environments, for multiple cells, for multiple geographic locations, etc.). In such cases, the same ML model on the second network device may be compatible with multiple different scenario-specific ML models on the first network device. In some examples, the first network device can include an ML model trained according to different scenarios. In some examples, the second network device can include an ML model trained for a specific scenario.

As noted above, in some aspects, the first network device can monitor the performance of the test ML model deployed on the first network device. For example, the first network device can compare the first compressed representation to the second compressed representation to determine a similarity or difference between the compressed representations. In another example, the first network device can reconstruct the control information (to generate a first reconstruction) based on the first compressed representation and reconstruct the control information (to generate a second reconstruction) based on the second compressed representation. The first network device can compare the first reconstruction and the second reconstruction to determine a similarity or difference between the first and second reconstructions. In such aspects, the first network device can transmit a result of the comparison to the second device, update the test ML model, switch to a different ML model (e.g., that is trained for a different scenario), any combination thereof, and/or perform any other suitable operation.

The first network device and the second network device can include any type of network device. For instance, in some examples, the first network device can include a user equipment (UE) and the second network device can include a base station (e.g., an eNodeB, a gNodeB, or other base station) or a portion of the base station (e.g., a central unit (CU), a distributed unit (DU), a radio unit (RU), or other portion of a base station having a disaggregated architecture). In some examples, the first network device can include a first UE and the second network device can include a second UE. In some examples, the first network device can include a base station or a portion of the baes station and the second network device can include a UE.

One example of a benefit of the systems and techniques described herein is that an ML model deployed at a device can be monitored for accuracy for a given channel. Another benefit is that the systems and techniques prevent the need to send the original control information (e.g., the target or ground truth control CSI) from the first network device to the second network device for performance monitoring.

Further details related to the systems and techniques described herein are provided with respect to the figures.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal can include an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

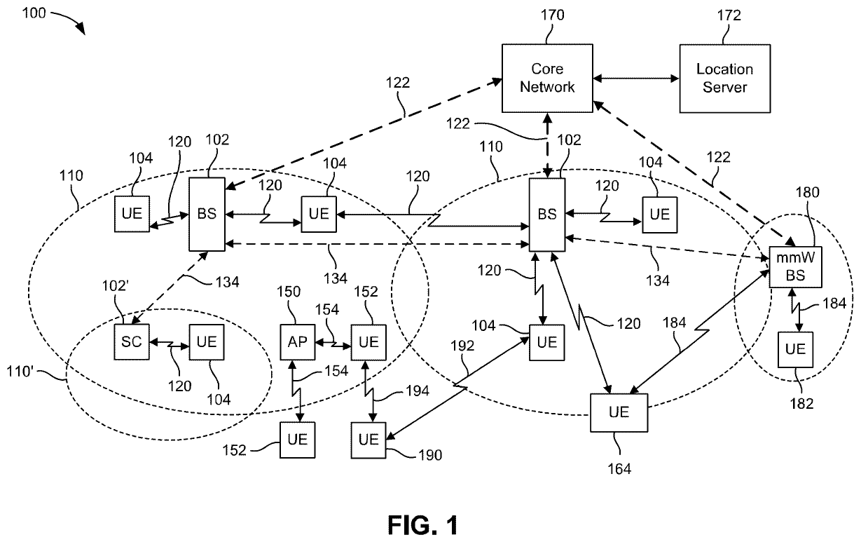

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′may have a coverage area 110′that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102-180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

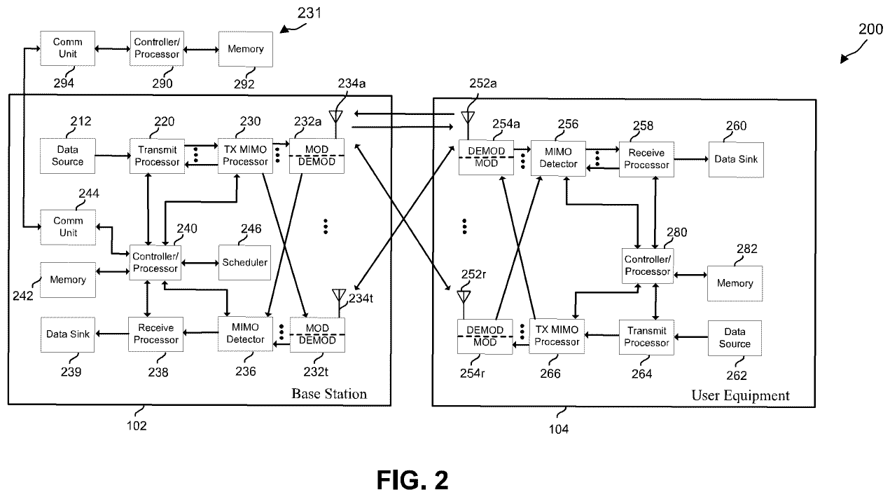

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

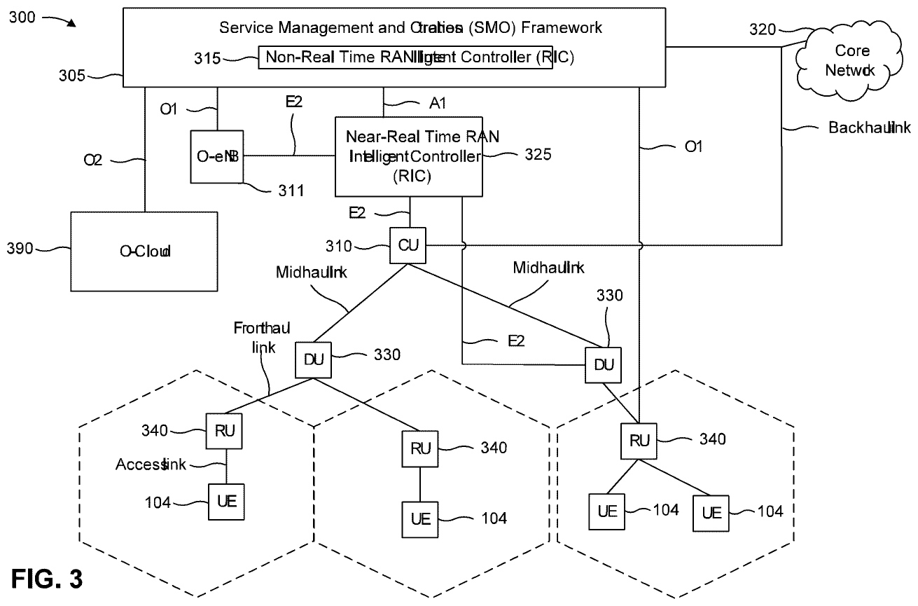

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

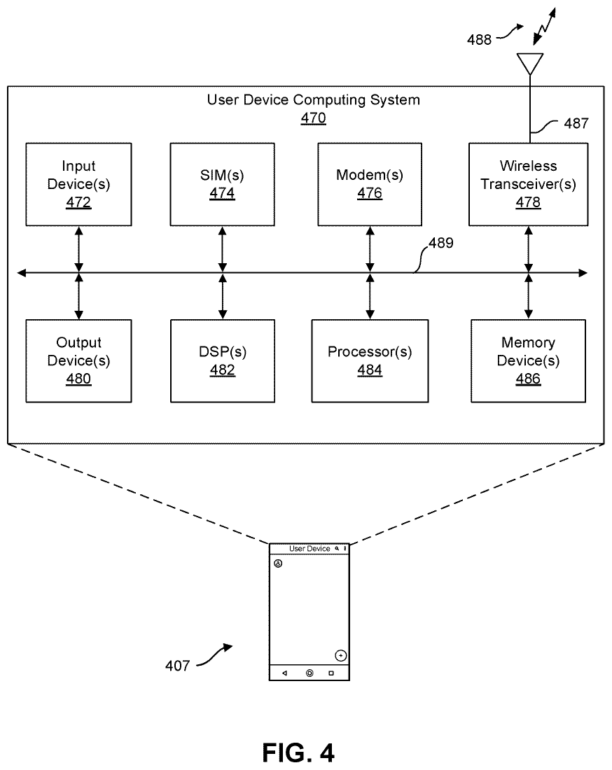

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth TM network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may include computer programs implementing the functions provided by various embodiments, and/or may be designed to implement methods and/or configure systems, as described herein.

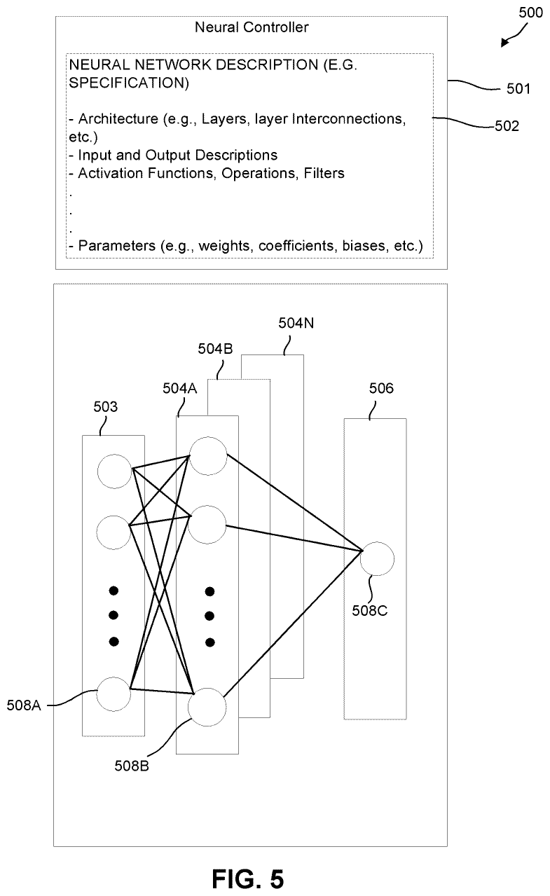

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

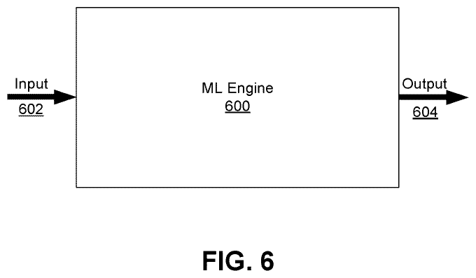

Increasingly ML (e.g., AI) algorithms (e.g., models) are being incorporated into a variety of technologies including wireless telecommunications standards. For example, as described herein, systems and techniques are described for using a reference ML model to monitor the performance of a test ML model. FIG. 6 is a block diagram illustrating an ML engine 600, in accordance with aspects of the present disclosure. As an example, one or more devices in a wireless system may include ML engine 600. In some cases, ML engine 600 may be similar to neural network 500. In this example, ML engine 600 receives and processes input 602 to generate an output 604. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a DRX schedule for a UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE. Also as noted above, the ML engine 600 configured on a UE can be trained to compress control information (e.g., CSI) and transmit the compressed control information over the air-interface to another device (e.g., a gNB, a UE, etc.).

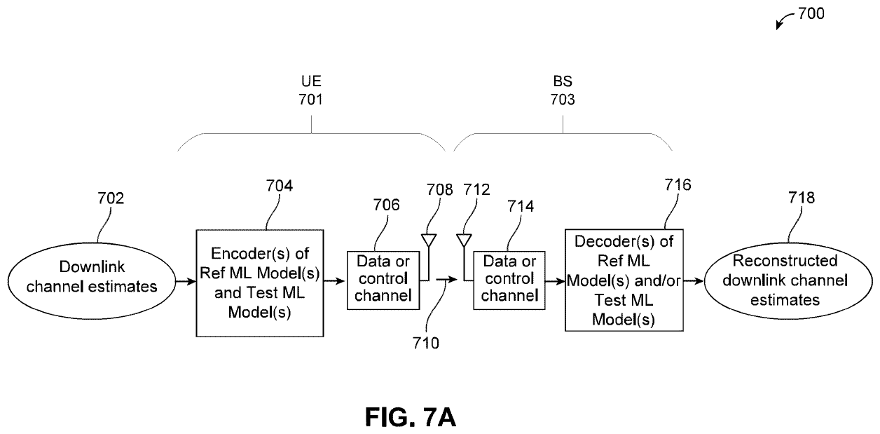

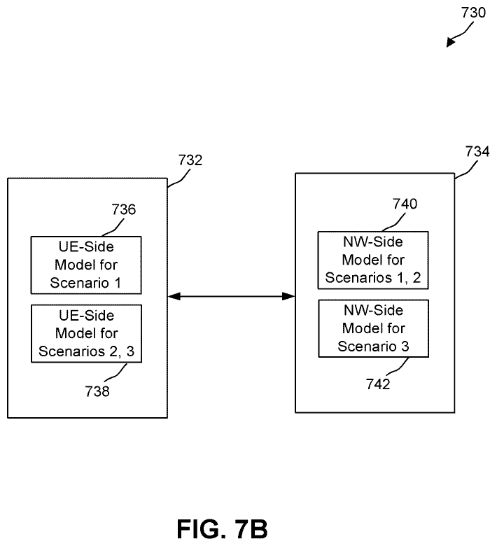

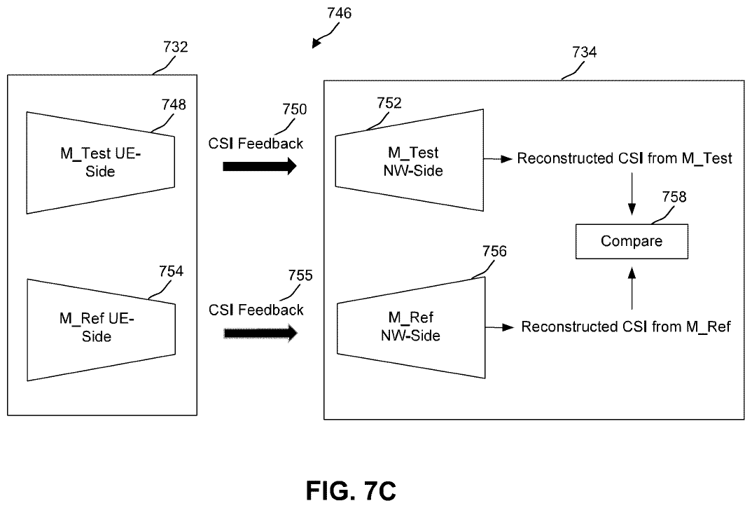

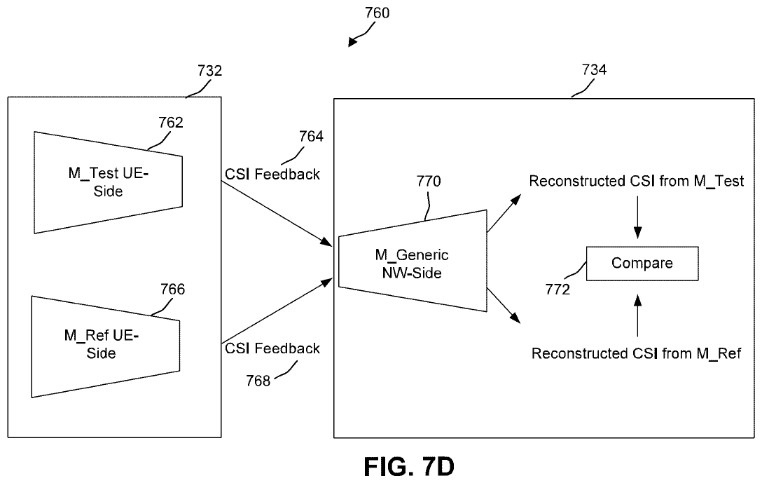

FIG. 7A is a diagram illustrating an example of a system 700 for implementing various aspects of monitoring a performance of a test ML model deployed on a network device. As shown in FIG. 7A, the system 700 includes a UE 701 and a base station 703. The base station 703 can include a gNB, eNB, or other type of base station, or a portion of a base station (e.g., a CU, DU, RU, or other portion of a base station having a disaggregated architecture). The UE 701 can determine downlink channel estimates 702 (as an example of control information), such as based on one or more received CSI-reference signals (CSI-RSs) received from a network device (e.g., a gNB), such as the base station 703, another base station, or other network device. The UE 701 can provide the downlink channel estimates 702 to a channel state information (CSI) encoder 704.

The CSI encoder 704 can include at least one reference ML model and at least one test ML model. While examples described herein use one reference ML model and one test ML model for illustrative purposes, one of ordinary skill will appreciate that the UE and/or other network device may include multiple reference ML models and/or multiple test ML models. Each of the test ML model and the reference ML model of the CSI encoder 704 can encode the downlink channel estimates 702 (e.g., CSI) to generate respective encoded or compressed representations of the downlink channel estimates 702. The encoded/compressed representation of the downlink channel estimates 702 can include a latent representation (e.g., a latent code) of the downlink channel estimates 702 (e.g., a latent code representing the CSI). For example, the latent representation can include a feature vector, tensor, array, or other representation including values representing the downlink channel estimates 702.

The UE 701 can transmit the encoded downlink channel estimates using antenna 708 via a data or control channel 706 over a wireless or air interface 710 to a receiving antenna 712 of the base station 703. The encoded or compressed downlink channel estimates 702 is provided via a data or control channel 714 to a CSI decoder 716 of the base station 703. The CSI decoder 716 can decode the encoded downlink channel estimates to generate a reconstructed downlink channel estimate 718. The decoder 716 can include the reference ML model and the test ML model as well. The encoder 704 can be on a UE and the decoder can be on a base station (e.g., a gNB) or a portion of the base station (e.g., a CU, DU, RU, etc.). The encoder output from the UE is transmitted to the base station as an input to the decoder 716. In one example, the encoder at a UE outputs a compressed channel state feedback (CSF), which is input to the decoder at the base station. The decoder at the base station outputs a reconstructed CSF, such as precoding vectors.

Aspects disclosed herein can thus be system or method associated with a gNB-server, a gNB that receives and performs a comparison analysis to monitor the performance of a test ML model, a UE-server and/or a UE that may also receive data associated with the performance of a test ML model for monitoring purposes. When the test ML model is not performing properly as determined by the monitoring, remedial steps can be taken such as switching to a different model or sending the full uncompressed data (e.g., such as the original CSI or CSF).

FIG. 7B illustrates in more detail a system 730 including a UE 732 that has configured thereon a UE-side model 736 trained for a first scenario (e.g., using training data specific to the first scenario), referred to as scenario 1, and another UE-side model 738 trained for one or more scenarios such as scenarios labeled as scenario 2 and scenario 3. As noted above, the different scenarios can include indoor use, outdoor use, line of sight (LOS) use, non-LOS use, UEs from a first UE vendor versus UEs from a second UE vendor, region-specific geographic locations, serving cell characteristics, abstract scenario classes based on different statistics of a channel such as delay spread, signal-to-noise ratio, ML-based features, and so forth. If the ML model (such as model 738) was trained for a certain scenario (e.g., an indoor environment), the model may not perform well in a different scenario (e.g., an outdoor environment).

On the network side, a gNB 734 may have a network-side model 740 trained for scenarios 1 and 2 and another network-side model 742 trained for scenario 3. By training the network-side model 740 according to scenarios 1 and 2, the model 740 can be compatible with many different scenario-specific UE-side models. For instance, the model 704 can allow the gNB 734 to accurately determine whether the model 736 and/or the model 738 are performing accurately for a given channel for which the channel estimates 702 were determined.

FIG. 7C illustrates a system 746 including a UE 732 and a network device 734 (e.g., a base station or portion thereof). The UE 732 include a UE-side test model 748 that generates compressed control information such as CSI feedback 750 and transmits the CSI feedback 750 to the network device 734. The network device 734 can decode the compressed CSI feedback 750 using a network-side test model 752. The output of the network-side test model 752 is a first version of reconstructed CSI feedback that corresponds to original (target) CSI feedback (e.g., the channel estimates 702 from FIG. 7A). As further illustrated in FIG. 7C, a UE-side reference model 754 generates compressed control information such as CSI feedback 755 and transmits the CSI feedback 755 data to a network node which decodes the compressed CSI feedback 855 using a network-side reference model 756. The output from the network-side reference model 756 is a second version of reconstructed CSI feedback that corresponds to the original (target) CSI feedback (e.g., the channel estimates 702 from FIG. 7A).

The network device 734 can then compare (at operation 758) the two versions of the reconstructed CSI feedback to determine whether the CSI feedback is similar (e.g., within a threshold difference). The closer the two reconstructions are, the better the performance of the UE-side model being tested 748. The result of the comparison operation can be a determination or comparison value, which can indicate whether the UE-side test model 748 is accurate for a communication channel for which the original (target) CSI feedback was determined. For example, if the difference between the first version of the reconstructed CSI feedback and the second version of the reconstructed CSI feedback is within the threshold difference, the network device 734 (or the UE 732) can determine that a performance of the UE-side test model 748 is accurate for the communication channel. If the difference between both versions of the reconstructed control information (e.g., reconstructed CSI) is greater than (or not below) the threshold difference, the network device 734 (or the UE 732) can determine that the performance of the UE-side test model 748 is inaccurate for the communication channel.

The network device 734 can transmit information indicative of the result of the comparison to the UE 732. For example, if the comparison value indicates that the test model 748 is performing accurately for the communication channel, then the UE 732 can continue to use the test model 748 to compress additional control information. However, if the model 748 is not performing accurately for the communication channel, then the UE 732 can switch to another ML model (e.g., which may be trained for a different scenario) for compressing additional control data, can further train the test model 748 using additional training data, can transmit the control information (e.g., CSI feedback) without compression, and/or perform one or more other operations.

The approach of monitoring the performance of a test model 748 can occur on one or both of the UE 732 and the gNB 734. For example, the gNB 734 might perform the comparison and/or also monitoring the performance of the test ML model 748. In another aspect, the reconstructed data can be transmitted back to the UE 732 for performance of the comparison step and taking further action based on the results of the comparison.

In one aspect, the UE 732 generates and transmits the two compressed representations 750, 755 to the gNB 734 and the comparison is performed after reconstruction on the gNB 734. However, other variations can also be applied. The reconstructed data for both the network-side test model 752 and the network-side reference model 756 might be transmitted back to the UE 732 and the comparison 758 can occur on the UE 732. In that case, the monitoring or the determination of the performance of the test model 748 is actually performed on the UE 732.

Information can be transmitted from the gNB 734 to the UE 732 based in general on a comparison performed on the gNB 734 associated with receiving the first and second compressed representations of the control information. In a more specific example, the comparison can be of a first reconstruction of the control information based on the first compressed representation of the control information and a second reconstruction of the control information based on the second compressed representation of the control information.

In one aspect, the UE 732 can provide metadata, a parameter or an indication along with the transmission of the compressed representations 750, 755, indicating that the different data are to be compared for monitoring the performance of the test model 748. The indication can be based on initial data known on the UE 732 such as how comparable the CSI feedback 750, 755 are to each other. The indication may also be provided based on how different a first environment is to a second environment as the UE 732 moves from one environment to another. For example, a large change in characteristics of the different environments might trigger the indicator to monitor the performance of the test UE-side model 748.

A model 748 that has been trained well will ensure that typical realizations of CSI (i.e., commonly occurring realizations that are not outliers or uncommon cases) can be reconstructed well and would indicate adequate performance of the model 748. In contrast, realizations outside the distribution of the training data will result in inaccurate reconstruction which is revealed in the comparison results 758. In this sense, the goal of model monitoring is to determine whether the realizations are out-of-distribution (OOD) or not.

As an example, a model M_indoor 748 may be trained on data collected in indoor situations such as in a home, an office, a stadium, or other indoor scenarios. A M_reference model 766 can be a model that is trained on the mix of both indoor and outdoor datasets, and also may allow a larger size of the compressed representation. In this case, if the UE 732 is currently using M_indoor 748, but the UE 732 moves outdoors, then the M_indoor model 748 will experience an OOD situation since the data is from outdoor scenario and this may result in poor performance.

The M_reference model 754, being trained on the mix of indoor and outdoor data, may produce realizations that are not OOD and the reconstructed CSI may be similar to the target CSI. Then, by comparing 758 the reconstructed CSI from M_ref 754 and M_indoor 748 the gNB 734 can detect whether the realization is OOD or not.

FIG. 7D illustrates a system 760 in which the UE 732 includes a UE-side test model 762 that generates first CSI feedback 764 for transmission to the gNB 734. The UE 734 also includes a UE-side reference model 766 that generates second CSI feedback 768 that is transmitted to the gNB 734. The gNB uses a generic network-side model 770 to reconstruct the first CSI feedback 764 and then uses the same generic network-side model 770 to reconstruct the second CSI feedback 768 and compares 772 the two reconstructions to determine whether the test UE-side model 762 is performing adequately.

The network may configure the test model 748, 762 for inference purposes, and the reference model 754, 766 for the purpose of model monitoring. The network in this scenario may trigger the UE 732 to use the test model 762 for inference. The network may additionally trigger the UE 732 to use the reference model 754, 766 for inference. In this case, inference using the reference model 766 may be triggered less frequently relative to using the test model 748, 762 to save computation requirement at the UE 732. The reference model may also be associated with a more relaxed processing time requirement relative to the test model. The triggering of which model to use can be based on one or more factors such as a location of the UE 732, a characteristic of the environment around the UE 732 (i.e., whether indoor or outdoor, etc.), a speed of movement of the UE 732, whether the UE is in a vehicle and/or the type of vehicle such as a train, plane or car, and so forth. There can be any number of triggering events that can cause UE 732 to switch to one or another model and also whether to monitor whether the chosen model is performing adequately.

In one aspect, an instruction to monitor the performance of a test model 748, 762 can occur in a periodic manner such as hourly, daily or any periodic time frame. The timing may also be based on a predicted schedule such as when the UE 732 arrives at an office or some location on a daily basis. For example, the UE 732 or other device may cause the performance monitoring as the user who owns the UE 732 arrives at work, or arrives home on a daily basis and according to either a predetermined time or a location of the UE 732. The user may manually request performance monitoring or may be presented with a graphical user interface to confirm a location or an environmental condition such that the performance of a ML model should be tested. A machine learning model can also be implemented to predict or infer whether a change in the AI/ML model 748 is needed or expected based on historical activity or trained activity or movement of the UE 732. In another aspect, the monitoring can occur based on some other event such as throughput degradation, high block error rate.

The example of FIG. 7D illustrates monitoring of the UE-side test model 762 only, based on the network-side model 770 being trained using training data that is specific to a broad range of scenarios. In such an example, a reference model is needed only on the UE-side, and the network-side model 770 can be used on for the network side (without being monitored by a reference model) since it is known to be generic to the broad range of scenarios. In some aspects, as described herein, a system (e.g., system 746, system 760, or other system) can monitor the end-to-end performance of both the UE-side and network-side models (where both of the UE-side and NW-side models are under test). In such cases, the reference models can include a UE-side reference model and a NW-side reference model. In other cases, a UE can have a UE-side model that is trained using training data that is specific to multiple scenarios (e.g., indoor and outdoor environments), and a base station can include a network-side test model that is tested using a reference model on the base station.

Information associated with the performance of the machine learning model under test can indicate that the machine learning model under test is inaccurate for the communication channel. The UE can then take remedial steps based on the information, such as switching to an alternate machine learning model for further communication with the device or an additional device. The UE may send uncompressed control information which takes more bandwidth, but which will be more accurate. The information associated with the performance of the machine learning model under test can indicate that the machine learning model under test is accurate for the communication channel. The UE may then continue to use the same model for further communication.

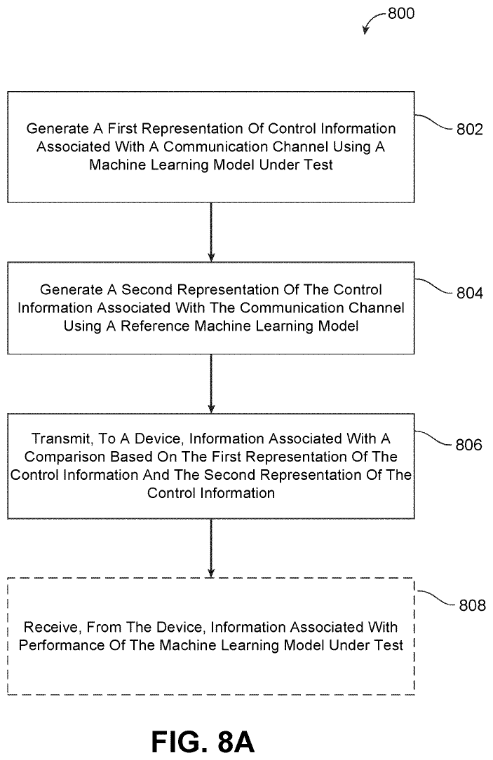

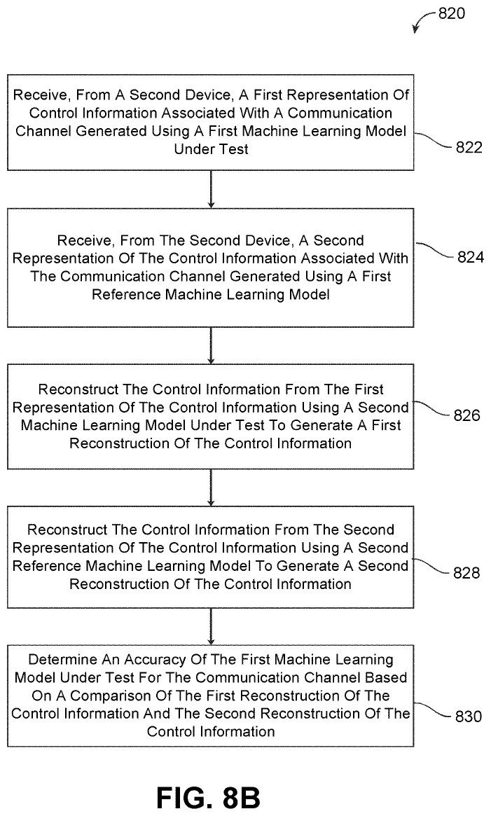

FIG. 8A is a flow diagram illustrating a process 800 for performing wireless communications at the UE. At block 802, the process 800 includes generating a first representation of control information associated with a communication channel using a machine learning model under test (referred to as a test machine learning model). In some examples, the control information can include channel state information (CSI) or channel state feedback (CSF) associated with the communication channel. In other examples, the control information can include other types of data other than CSI or CSF. In some aspects, the machine learning model can generate the representation of the control information based on a rate-distortion trade-off, which provides a trade-off between a size of the representation and an accuracy of a reconstructed version of the control information (e.g., a distortion between the reconstructed control information and the original control information). For instance, in some cases, a goal may be to compress (reduce the size of) the control information (e.g., the CSI or CSF message), in which case the first representation can include a first compressed representation of the control information. In other cases, a goal may be to improve the accuracy of the reconstructed control information (e.g., the reconstructed CSI or CSF).

At block 804, the process 800 includes generating a second representation of the control information associated with the communication channel using a reference machine learning model. In some cases, the second representation can include a second compressed representation of the control information. In some aspects, the test machine learning model can include a first encoder neural network model (e.g., UE-side test model 748, UE-side test model 762, or other model) trained to compress control information of a first environment into a compressed representation. In some aspects, the reference machine learning model can include a second encoder neural network model (e.g., the UE-side reference model 754, the UE-side reference model 766, or other model) trained to compress control information of the first environment and a second environment into a compressed representation. In one illustrative example, the first environment can include an indoor environment and the second environment includes an outdoor environment. Many other environments are contemplated as well.

At block 806, the process 800 includes transmitting, to a device, information associated with a comparison based on the first representation of the control information and the second representation of the control information. The device can perform a comparison of the first representation of the control information and the second representation of the control information for monitoring a performance of the test machine learning model 748, 762. In some cases, the device can perform the comparison on the raw representations. In other cases, when the representations are compressed (referred to herein as compressed representations), the device can process the first representation of the control information using a first decoder to generate a first reconstructed representation of the control information and can process the second representation of the control information using a second decoder to generate a second reconstructed representation of the control information. In such cases, the device can then compare the first reconstructed representation of the control information with the second reconstructed representation of the control information to yield the comparison.

In some cases, the device can also perform the comparison and can transmit the information associated with the comparison to the device as a result of the comparison.

In some aspects, such as at block 808, the process 800 can include receiving, from the device, information associated with performance of the machine learning model under test. In some examples, the information associated with the comparison of the first reconstruction of the control information and the second reconstruction of the control information can indicate that the machine learning model under test is inaccurate for the communication channel. In such examples, the process 800 can further include, based on the information indicating that the machine learning model under test is inaccurate for the communication channel, switching to an alternate machine learning model for further communication with the device or an additional device. In some examples, the information associated with the comparison based on the first presentation of the control information and the second representation of the control information indicates that machine learning model under test is accurate for the communication channel. In such examples, the process 800 can further include, based on the information indicating that the machine learning model under test is accurate for the communication channel, continuing to use the machine learning model under test.

In another aspect, the method can include updating, based at least in part on the information, the machine learning model under test to generate an updated machine learning model or receiving, from the device, information including a first trigger to use the machine learning model under test and generating the first representation of the control information using the machine learning model under test based on the first trigger.

In some aspects, the process 800 can include receiving, from the device, information including a second trigger to use the reference machine learning model and generating the second representation of the control information using the reference machine learning model based on the second trigger. In some cases, use of the machine learning model under test can be triggered more frequently than use of the reference machine learning model.

In some aspects, use of at least one of the machine learning model under test or use of the reference machine learning model can be triggered based on an event. The event can include at least one of the UE moving to a new environment for which the test machine learning model was not trained, a degradation of throughput via the communication channel, a high block error rate (BLER) condition, or a periodical time to monitor a performance of the machine learning model under test. The machine learning model under test can be configured on the UE or the device or base station.

FIG. 8B illustrates a process 820 for wireless communications at a first device. In some cases, the first network device can be a gNB 734 or other network device. At block 822, the process 820 can include receiving, from a second device, a first representation of control information associated with a communication channel generated using a first machine learning model under test. The second network device can be a UE 732 or other device. At block 824, the process 820 can include receiving, from the second device, a second compressed representation of the control information associated with the communication channel generated using a first reference machine learning model.

At block 826, the process 820 can include, reconstructing the control information from the first representation of the control information using a second test machine learning model to generate a first reconstruction of the control information. At block 828, the process 820 can include, reconstructing the control information from the second representation of the control information using a second reference machine learning model to generate a second reconstruction of the control information. At block 830, the process 820 can include determining an accuracy of the first machine learning model under test for the communication channel based on a comparison of the first reconstruction of the control information and the second reconstruction of the control information (830). The representations of the control information can be compressed at the first device. The first device and the second device can be either a UE or a base station or gNB.

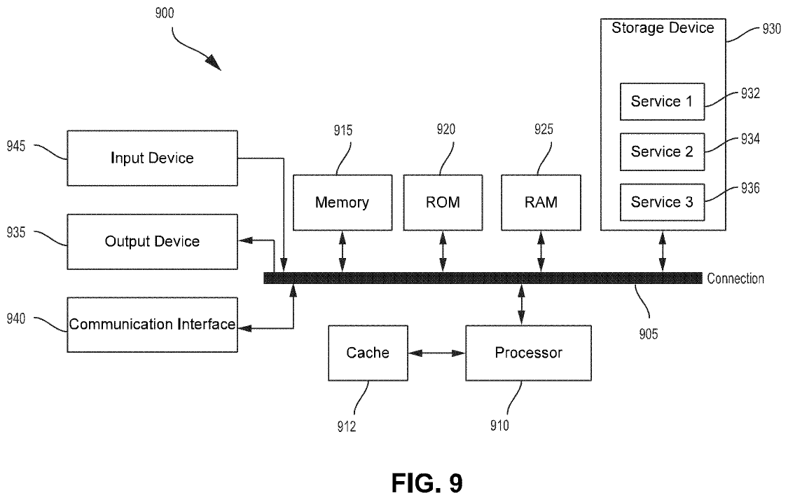

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A method of wireless communication performed at a user equipment (UE), the method comprising: generating a first representation of control information associated with a communication channel using a machine learning model under test; generating a second representation of the control information associated with the communication channel using a reference machine learning model; and transmitting, to a device, information associated with a comparison based on the first representation of the control information and the second representation of the control information.

Aspect 2. The method of Aspect 1, wherein the first representation of the control information and the second representation of the control information is transmitted to the device for performing the comparison of the first representation of the control information and the second representation of the control information for monitoring a performance of the machine learning model under test.

Aspect 3. The method of any of Aspects 1 or 2, wherein the first representation of the control information and the second representation of the control information is transmitted to the device for processing the first representation of the control information using a first decoder to generate a first reconstructed representation of the control information, processing the second representation of the control information using a second decoder to generate a second reconstructed representation of the control information, and performing the comparison at least in part by comparing the first reconstructed representation of the control information with the second reconstructed representation of the control information.

Aspect 4. The method of Aspect 1, further comprising performing the comparison and transmitting the information associated with the comparison to the device as a result of the comparison.

Aspect 5. The method of any of Aspects 1 to 4, wherein the control information comprises channel state information associated with the communication channel.

Aspect 6. The method of any of Aspects 1 to 5, wherein the machine learning model under test comprises a first encoder neural network model trained to compress control information while operating in a first environment into a first compressed representation, and wherein the reference machine learning model comprises a second encoder neural network model trained to compress control information while operating in the first environment and a second environment into a second compressed representation.

Aspect 7. The method of any of Aspects 1 to 6, wherein the first environment includes an indoor environment, and wherein the second environment includes an outdoor environment.

Aspect 8. The method of any of Aspects 1 to 7, further comprising: receiving, from the device, information associated with performance of the machine learning model under test.

Aspect 9. The method of any of Aspects 1 to 8, wherein the information associated with the performance of the machine learning model under test indicates that the machine learning model under test is inaccurate for the communication channel.

Aspect 10. The method of any of Aspects 1 to 9, further comprising: based on the information indicating that the machine learning model under test is inaccurate for the communication channel, switching to an alternate machine learning model for further communication with the device or an additional device.

Aspect 11. The method of any of Aspects 1 to 10, wherein the information associated with the performance of the machine learning model under test indicates that the machine learning model under test is accurate for the communication channel.

Aspect 12. The method of any of Aspects 1 to 11, further comprising: based on the information indicating that the machine learning model under test is accurate for the communication channel, continuing to use the machine learning model under test.

Aspect 13. The method of any of Aspects 1 to 12, further comprising: updating, based at least in part on the information, the machine learning model under test to generate an updated machine learning model.

Aspect 14. The method of any of Aspects 1 to 13, further comprising: receiving, from the device, information including a first trigger to use the machine learning model under test; and generating the first representation of the control information using the machine learning model under test based on the first trigger.

Aspect 15. The method of any of Aspects 1 to 14, further comprising: receiving, from the device, information including a second trigger to use the reference machine learning model; and generating the second representation of the control information using the reference machine learning model based on the second trigger.

Aspect 16. The method any of Aspects 1 to 15, wherein use of the machine learning model under test is triggered more frequently than use of the reference machine learning model.

Aspect 17. The method of any of Aspects 1 to 16, wherein use of at least one of the machine learning model under test or use of the reference machine learning model is triggered based on an event.

Aspect 18. The method of any of Aspects 1 to 17, wherein the event comprises at least one of the UE moving to a new environment for which the machine learning model under test was not trained, a degradation of throughput via the communication channel, a high block error rate (BLER) condition, or a periodical time to monitor a performance of the machine learning model under test.

Aspect 19. The method of any of Aspects 1 to 18, wherein the device comprises a base station.

Aspect 20 An apparatus for wireless communications comprises: at least one memory; and at least one processor coupled to the at least one memory, the at least one processor configured to: generate a first representation of control information associated with a communication channel using a machine learning model under test; generate a second representation of the control information associated with the communication channel using a reference machine learning model; and transmit, to a device, information associated with a comparison based on the first representation of the control information and the second representation of the control information.

Aspect 21. The apparatus of Aspect 20, wherein the device performs the comparison of the first representation of the control information and the second representation of the control information for monitoring a performance of the machine learning model under test.

Aspect 22. The apparatus of any of Aspects 20 or 21, wherein the first representation of the control information and the second representation of the control information is transmitted to the device for processing the first representation of the control information using a first decoder to generate a first reconstructed representation of the control information, processing the second representation of the control information using a second decoder to generate a second reconstructed representation of the control information, and performing the comparison at least in part by comparing the first reconstructed representation of the control information with the second reconstructed representation of the control information.

Aspect 23. The apparatus of Aspect 20, wherein the apparatus performs the comparison and transmits the information associated with the comparison to the device as a result of the comparison.

Aspect 24. The apparatus of any of Aspects 20 to 23, wherein the control information comprises channel state information associated with the communication channel.

Aspect 25. The apparatus of any of Aspects 20 to 24, wherein the machine learning model under test comprises a first encoder neural network model trained to compress control information while operating in a first environment into a first compressed representation, and wherein the reference machine learning model comprises a second encoder neural network model trained to compress control information while operating in the first environment and a second environment into a second compressed representation.

Aspect 26. The apparatus of any of Aspects 20 to 25, wherein the first environment includes an indoor environment, and wherein the second environment includes an outdoor environment.

Aspect 27. The apparatus of any of Aspects 20 to 26, wherein the at least one processor is further configured to: receive, from the device, information associated with performance of the machine learning model under test.

Aspect 28. The apparatus of any of Aspects 20 to 27, wherein the information associated with the performance of the machine learning model under test indicates that the machine learning model under test is inaccurate for the communication channel.

Aspect 29. The apparatus of any of Aspects 20 to 28, wherein the at least one processor is further configured to: based on the information indicating that the machine learning model under test is inaccurate for the communication channel, switch to an alternate machine learning model for further communication with the device or an additional device.

Aspect 30. The apparatus of any of Aspects 20 to 29, wherein the information associated with the performance of the machine learning model under test indicates that the machine learning model under test is accurate for the communication channel.

Aspect 31. The apparatus of any of Aspects 20 to 30, wherein the at least one processor is further configured to: based on the information indicating that the machine learning model under test is accurate for the communication channel, continue to use the machine learning model under test.

Aspect 32. The apparatus of any of Aspects 20 to 31, wherein the at least one processor is further configured to: updating, based at least in part on the information, the machine learning model under test to generate an updated machine learning model.

Aspect 33. The apparatus of any of Aspects 20 to 32, wherein the at least one processor is further configured to: receive, from the device, information including a first trigger to use the machine learning model under test; and generate the first representation of the control information using the machine learning model under test based on the first trigger.

Aspect 34. The apparatus of any of Aspects 20 to 33, wherein the at least one processor is further configured to: receive, from the device, information including a second trigger to use the reference machine learning model; and generate the second representation of the control information using the reference machine learning model based on the second trigger.

Aspect 35. The apparatus of any of Aspects 20 to 34, wherein use of the machine learning model under test is triggered more frequently than use of the reference machine learning model.

Aspect 36. The apparatus of any of Aspects 20 to 35, wherein use of at least one of the machine learning model under test or use of the reference machine learning model is triggered based on an event.

Aspect 37. The apparatus of any of Aspects 20 to 36, wherein the event comprises at least one of the UE moving to a new environment for which the machine learning model under test was not trained, a degradation of throughput via the communication channel, a high block error rate (BLER) condition, or a periodical time to monitor a performance of the machine learning model under test.

Aspect 38. The apparatus of any of Aspects 20 to 37, wherein the device comprises a base station.

Aspect 39. A method of wireless communication at a first device, the method comprising: receiving, from a second device, a first representation of control information associated with a communication channel generated using a first machine learning model under test; receiving, from the second device, a second representation of the control information associated with the communication channel generated using a first reference machine learning model; reconstructing, at the first device, the control information from the first representation of the control information using a second machine learning model under test to generate a first reconstruction of the control information; reconstructing, at the first device, the control information from the second representation of the control information using a second reference machine learning model to generate a second reconstruction of the control information; and determining, at the first device, an accuracy of the first machine learning model under test for the communication channel based on a comparison of the first reconstruction of the control information and the second reconstruction of the control information.

Aspect 40. The method of claim 39, wherein the second machine learning model under test includes a first decoder configured to generate the first reconstruction of the control information, and wherein the second reference machine learning model includes a second decoder configured to generate the second reconstruction of the control information.

Aspect 41. An apparatus for wireless communications comprises at least one memory; and at least one processor coupled to the at least one memory, the at least one processor configured to: receive, from a device, a first representation of control information associated with a communication channel generated using a first machine learning model under test; receive, from the device, a second representation of the control information associated with the communication channel generated using a first reference machine learning model; reconstruct, at the apparatus, the control information from the first representation of the control information using a second machine learning model under test to generate a first reconstruction of the control information; reconstruct, at the apparatus, the control information from the second representation of the control information using a second reference machine learning model to generate a second reconstruction of the control information; and determine, at the apparatus, an accuracy of the first machine learning model under test for the communication channel based on a comparison of the first reconstruction of the control information and the second reconstruction of the control information.

Aspect 42. The apparatus of claim 41, wherein the second machine learning model under test includes a first decoder configured to generate the first reconstruction of the control information, and wherein the second reference machine learning model includes a second decoder configured to generate the second reconstruction of the control information.

Aspect 43. A non-transitory computer-readable storage medium comprising instructions stored thereon which, when executed by at least one processor, causes the at least one processor to perform operations according to any of claims 1-19 and/or claims 39-40.

1. A method of wireless communication performed at a user equipment (UE), the method comprising:
generating a first representation of control information associated with a communication channel using a machine learning model under test;
generating a second representation of the control information associated with the communication channel using a reference machine learning model; and
transmitting, to a device, information associated with a comparison based on the first representation of the control information and the second representation of the control information.

2-19. (canceled)

20. An apparatus for wireless communications comprises:
at least one memory; and
at least one processor coupled to the at least one memory, the at least one processor configured to:
generate a first representation of control information associated with a communication channel using a machine learning model under test;
generate a second representation of the control information associated with the communication channel using a reference machine learning model; and
transmit, to a device, information associated with a comparison based on the first representation of the control information and the second representation of the control information.

21. The apparatus of claim 20, wherein the at least one processor is configured to transmit the first representation of the control information and the second representation of the control information to the device for performing the comparison of the first representation of the control information and the second representation of the control information for monitoring a performance of the machine learning model under test.

22. The apparatus of claim 20, wherein the first representation of the control information and the second representation of the control information is transmitted to the device for processing the first representation of the control information using a first decoder to generate a first reconstructed representation of the control information, processing the second representation of the control information using a second decoder to generate a second reconstructed representation of the control information, and performing the comparison at least in part by comparing the first reconstructed representation of the control information with the second reconstructed representation of the control information.

23. The apparatus of claim 20, wherein the at least one processor is configured to:
perform the comparison; and
transmit the information associated with the comparison to the device as a result of the comparison.

24. The apparatus of claim 20, wherein the control information comprises channel state information associated with the communication channel.

25. The apparatus of claim 20, wherein the machine learning model under test comprises a first encoder neural network model trained to compress control information while operating in a first environment into a first compressed representation, and wherein the reference machine learning model comprises a second encoder neural network model trained to compress control information while operating in the first environment and a second environment into a second compressed representation.

26. The apparatus of claim 25, wherein the first environment includes an indoor environment, and wherein the second environment includes an outdoor environment.

27. The apparatus of claim 20, wherein the at least one processor is further configured to:
receive, from the device, information associated with performance of the machine learning model under test.

28. The apparatus of claim 27, wherein the information associated with the performance of the machine learning model under test indicates that the machine learning model under test is inaccurate for the communication channel.

29. The apparatus of claim 28, wherein the at least one processor is further configured to:
based on the information indicating that the machine learning model under test is inaccurate for the communication channel, switch to an alternate machine learning model for further communication with the device or an additional device.

30. The apparatus of claim 29, wherein information associated with the performance of the machine learning model under test indicates that the machine learning model under test is accurate for the communication channel.

31. The apparatus of claim 30, wherein the at least one processor is further configured to:
based on the information indicating that the machine learning model under test is accurate for the communication channel, continue to use the machine learning model under test.

32. The apparatus of claim 27, wherein the at least one processor is further configured to:
updating, based at least in part on the information associated with the performance of the machine learning model under test, the machine learning model under test to generate an updated machine learning model.

33. The apparatus of claim 20, wherein the at least one processor is further configured to:
receive, from the device, information including a first trigger to use the machine learning model under test; and
generate the first representation of the control information using the machine learning model under test based on the first trigger.

34. The apparatus of claim 20, wherein the at least one processor is further configured to:
receive, from the device, information including a second trigger to use the reference machine learning model; and
generate the second representation of the control information using the reference machine learning model based on the second trigger.

35. The apparatus of claim 34, wherein use of the machine learning model under test is triggered more frequently than use of the reference machine learning model.

36. The apparatus of claim 20, wherein use of at least one of the machine learning model under test or use of the reference machine learning model is triggered based on an event.
wherein the event comprises at least one of the apparatus moving to a new environment for which the machine learning model under test was not trained, a degradation of throughput via the communication channel, a high block error rate (BLER) condition, or a periodical time to monitor a performance of the machine learning model under test.

37. (canceled)

38. The apparatus of claim 20, wherein the device comprises a network entity.

39-40. (canceled)

41. An apparatus for wireless communications comprises:
at least one memory; and
at least one processor coupled to the at least one memory, the at least one processor configured to:
receive, from a device, a first representation of control information associated with a communication channel generated using a first machine learning model under test;
receive, from the device, a second representation of the control information associated with the communication channel generated using a first reference machine learning model;
reconstruct, at the apparatus, the control information from the first representation of the control information using a second machine learning model under test to generate a first reconstruction of the control information;
reconstruct, at the apparatus, the control information from the second representation of the control information using a second reference machine learning model to generate a second reconstruction of the control information; and
determine, at the apparatus, an accuracy of the first machine learning model under test for the communication channel based on a comparison of the first reconstruction of the control information and the second reconstruction of the control information.

42-44. (canceled)
